(19) United States
(12) Patent Application Publication
(10) Pub. No.: US 2025/0238568 A1
(43) Pub. Date: Jul. 24, 2025

(54) MANUFACTURING FIXTURE DESIGN TO IMPROVE SENSOR DATA AND/OR FIXTURE PERFORMANCE DURING MANUFACTURING USING THE FIXTURE

(71) Applicant: Autodesk, Inc., San Francisco, CA (US)

(72) Inventors: Bowen Lorenzini Christopher, Waterford, VT (US); Riley Scott Ronald Peterson, Greeley, CO (US)

(21) Appl. No.: 18/418,123

(22) Filed: Jan. 19, 2024

(51) Int. Cl. G06F 30/17

(52) U.S. Cl. CPC G06F 30/17

(57) ABSTRACT

Methods, systems, and apparatus, including medium-encoded computer program products, for manufacturing fixture design include: obtaining a toolpath specification to be used in a manufacturing process for a physical structure using a fixture; simulating the manufacturing process using the toolpath specification and a placement of sensor(s) at location(s) for the fixture and/or the physical structure, including producing simulated data for the sensor(s) at the location(s) in accordance with the placement; modifying a three-dimensional model of the fixture based on the simulated data to improve (i) data quality for the sensor(s) at the location(s), and/or (ii) performance of the fixture, during the manufacturing process; and providing the three-dimensional model of the fixture for use during the manufacturing process using the fixture and the sensor(s) at the location(s).

### BACKGROUND

### Technical Field

This specification relates to computer aided design of physical structures, which can be manufactured using subtractive manufacturing systems and techniques in addition to additive manufacturing and/or other manufacturing systems and techniques.

### Description of Related Art

Computer Aided Design (CAD) software has been developed and used to generate three-dimensional (3D) representations of objects, and Computer Aided Manufacturing (CAM) software has been developed and used to manufacture the physical structures of those objects, e.g., using Computer Numerical Control (CNC) manufacturing techniques. Further, CAD programs have been used in conjunction with subtractive manufacturing systems and techniques. Subtractive manufacturing refers to any manufacturing process where 3D objects are created from stock material (generally referred to as a “blank” or “workpiece”) that is larger than the 3D object by cutting away portions of the stock material, e.g., using one or more fixtures to hold the stock material and thus the part in place during the manufacturing process. For example, U.S. Pat. No. 11,307,559 describes technologies relating to producing holding tabs for manufacturing by assessing predicted cutting forces experienced by a workpiece during computer-controlled machining.

In addition to CNC machining, other subtractive manufacturing techniques include electrode discharge machining, chemical machining, waterjet machining, etc. In contrast, additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Other manufacturing techniques for building 3D objects from raw materials include casting, forging (both hot and cold), and welding.

Moreover, CAD software has been designed so as to perform automatic generation of 3D geometry (generative design) for a part or one or more parts in a larger system of parts to be manufactured. This automated generation of 3D geometry is often limited to a design space specified by a user of the CAD software, and the 3D geometry generation is typically governed by design objectives and constraints, which can be used to drive the geometry generation process toward better designs, and can take into consideration the forces to be experienced during subtractive manufacturing. For example, U.S. Pat. No. 11,200,355 describes technologies relating to computer aided design of physical structures using generative design processes, such that manufacturing of the physical structures using subtractive manufacturing systems and techniques (in addition to using additive manufacturing and/or other manufacturing systems and techniques) is facilitated by the design processes.

### SUMMARY

This specification describes technologies relating to manufacturing fixture design to improved sensor data and/or fixture performance during manufacturing using the fixture, and in particular, to systems and techniques that add sensors to fixtures at selected and specifically-designed locations to improve manufacturing using such fixtures.

In general, one or more aspects of the subject matter described in this specification can be embodied in one or more methods (and also one or more non-transitory computer-readable mediums tangibly encoding a computer program operable to cause data processing apparatus to perform operations) including: obtaining a toolpath specification to be used in a manufacturing process for a physical structure in a computer-controlled manufacturing system (e.g., for a part to be manufactured by the computer-controlled manufacturing system) using a fixture to hold the physical structure; simulating the manufacturing process using the toolpath specification and a placement of one or more sensors at one or more locations on and/or in the fixture and/or on and/or in the physical structure, wherein the simulating produces simulated data for the one or more sensors at the one or more locations in accordance with the placement; modifying a three-dimensional model of the fixture based on the simulated data to improve (i) data quality for the one or more sensors at the one or more locations, and/or (ii) performance of the fixture, during the manufacturing process; and providing the three-dimensional model of the fixture for use during the manufacturing process actually performed by the computer-controlled manufacturing system using the fixture and the one or more sensors at the one or more locations. Other embodiments of this aspect include corresponding systems, apparatus, and computer program products recorded on one or more computer storage devices, each configured to perform the actions of the methods.

Note that a fixture is a work-holding or support device used in the manufacturing industry, where fixtures are used to securely locate (position in a specific location and/or orientation) and support the workpiece of the part, ensuring that all parts produced using the fixture will maintain conformity and interchangeability. In general, the fixture is considered to be a separate piece from the workpiece of the part, such as a separate fixture that holds the workpiece while subtractive manufacturing (e.g., milling) removes portions of the workpiece to form the part and/or while the workpiece of the part is attached to (e.g., thru welding) or assembled with another part. However, in some cases (e.g., three or more axis CNC machining, such as in a 5-axis tabbing manufacturing workflows) the fixture is formed from a same stock material as the workpiece of the part itself and standard clamping tools are attached to the stock material (e.g., a blank from which the part is milled) and the separate fixture portion of the stock material (e.g., holding tabs for the part as it is milled out of the blank) holds the part in place during manufacturing.

Various embodiments of the subject matter described in this specification can be implemented to realize one or more of the following advantages. Workflow limitations and issues associated with fixture design for subtractive manufacturing (machining/milling), welding, and/or additive manufacturing can be eliminated or reduced. Automated shape synthesis systems and techniques (i.e., automated design of physical structures, e.g., including automated modeling and/or generative design processes) can be used to design a fixture, which is then used in manufacturing, where the design process for the fixture reduces the total amount of time needed to design the fixture for use in manufacturing a specific part/physical structure. Moreover, the fixture design process using automated shape synthesis can employ simulation to determine an optimized placement of one or more sensors on and/or in the fixture and/or on and/or in the physical structure that is manufactured.

The fixture design process can close the information loop between how a fixture is designed to hold a part and how the part is actually held during manufacturing, along with determination of whether the part is held correctly by the fixture. This can facilitate the manufacturing of more complicated parts/physical structures, where those parts/physical structures can themselves be designed using one or more automated shape synthesis processes, such as generative design processes, and the initial workpiece of the part can be built using additive manufacturing. This facilitation of manufacturing can include improving both the alignment of the part and the holding of the part during manufacturing. This facilitation can support large scale manufacturing of generatively designed and/or additively manufactured parts/structures. Note that the fixture can hold a part/structure for milling (e.g., parting off operations) and/or for other manufacturing operations (e.g., assembly, including welding).

In addition to facilitating the design of the fixture to improve alignment and/or holding, the fixture design process can employ simulation techniques to determine when, where and how to integrate sensors into the fixture and/or the part, which enables faster trouble shooting and error detection during fixture design and/or during manufacturing using the fixture. The simulation can also be used to improve the design of the fixture by changing its shape and/or topology in a manner that facilitates obtaining usable data from the one or more sensors in the physical world during the manufacturing of the part. For example, material can be added and/or removed from the fixture being designed to cause it to move (e.g., flex) in expected ways during the actual manufacturing, where that expected movement can be measured with one or more sensors in order to detect a failure of the manufacturing process (potentially before the failure actually occurs and the part is still salvageable) which enables more active manufacturing (e.g., machining) processes. Moreover, in a testing phase of fixture design, actual data from the one or more sensors can be captured during a test manufacturing process, and this actual data from the physical world can then be fed back into the simulation of the manufacturing using the fixture to calibrate the simulation for use in further improvement of the fixture design before it is finalized for use in large scale manufacturing. Finally, output data from analytics engine technology (e.g., which is used by a manufacturing enterprise that will use the fixture) can be used to further improve the manufacturing simulation and/or the final fixture design before it is used in large scale manufacturing.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to design a fixture for manufacturing and to manufacture physical structures using the fixture.

FIG. 2 shows examples of processes for designing a fixture, and optionally sensor placement, based on simulated manufacturing and sensor feedback.

FIG. 3 shows examples of processes that initially creates a fixture and optionally determines one or more sensors for the fixture.

FIG. 4 shows examples of processes that recalibrate simulated manufacturing for fixture design, effect a fixture digital twin, and/or adjust a manufacturing process based on real-world data captured using one or more sensors on and/or in the fixture during manufacturing of a part using the fixture.

FIG. 5 shows an example of processes that add sensor(s) for a fixture and then modify the fixture based on simulated loads and sensor feedback.

FIG. 6 shows an example of a process that defines a moving and static jaw on a softjaw fixture.

FIG. 7 shows an example of a process that calibrates an automated fixture design process.

FIG. 8 shows an example of a process that creates an as-built fixture for a digital twin.

FIG. 9 is a schematic diagram of a data processing system including a data processing apparatus, which can be programmed as a client or as a server.

Like reference numbers and designations in the various drawings indicate like elements.

### DETAILED DESCRIPTION

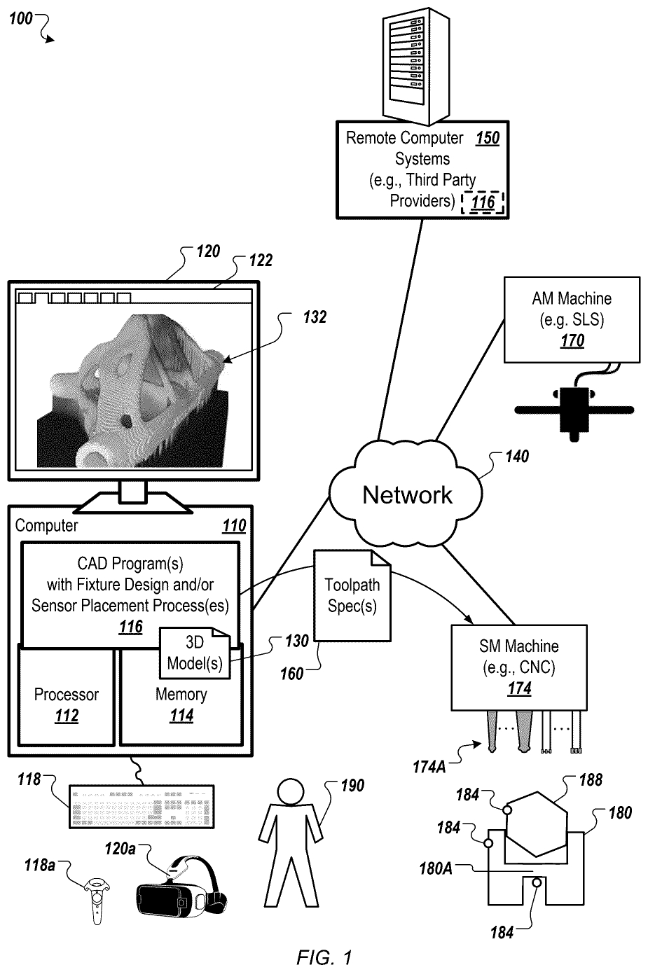

FIG. 1 shows an example of a system 100 usable to design a fixture for manufacturing and to manufacture physical structures using the fixture. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and nonvolatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which implement one or more fixture design and/or sensor placement processes described in this specification.

As used herein, “CAD” refers to any suitable program used to design fixtures with optional sensors for use in manufacturing physical structures, regardless of whether or not the program is capable of interfacing with and/or controlling specific manufacturing equipment. Thus, CAD program(s) 116 can include Computer Aided Engineering (CAE) program(s), Computer Aided Manufacturing (CAM) program(s), etc. In some implementations, the CAD program(s) 116 can implement manufacturing control functions, and in some other implementations, the program(s) 116 do not implement manufacturing control functions. The program(s) 116 can run locally on computer 110, remotely on a computer of one or more remote computer systems 150 (e.g., one or more third party providers' one or more server systems accessible by the computer 110 via the network 140) or both locally and remotely. Thus, a CAD program 116 can be two or more programs that operate cooperatively on two or more separate computer processors in that a program 116 operating locally at computer 110 can offload processing operations (e.g., generative design and/or physical numerical simulation operations) “to the cloud” by having one or more programs 116 on one or more computers 150 perform the offloaded processing operations.

In any case, in some implementations, the program(s) 116 perform shape synthesis to design a fixture 180 for holding a part during manufacturing of that part. Shape synthesis (i.e., automated design of physical structures) is used to design the fixture 180 that is then used in manufacturing for a physical structure 188 (e.g., a part, which can be incorporated into an apparatus and/or a system of parts). In general, the fixture 180 can be produced for use with an assembly, a weldment, or a part, during a manufacturing process. The fixture design's shape synthesis process can employ an automated modeling process or a generative design process, and can use numerical simulation (also referred to as simply “simulation”) of the manufacturing process to reduce fixture design time and/or to improve the operational functionality of the fixture 180 when it is used in manufacturing.

Note that (as used herein) a generative design process is more specific than an automated modeling process in that a generative design process also uses one or more boundary conditions such one or more loading conditions (e.g., provided by a user or defined by the program) to govern shape modifications during shape (and optionally topology) changes (e.g., optimization) but an automated modeling process has no predefined boundary conditions. Moreover, the shape synthesis process can employ material or microstructure techniques and/or geometrical or macrostructure techniques and can include Solid Isotropic Material with Penalization (SIMP) and/or level-set methods for shape and/or topology optimization.

Further, in some implementations, the program(s) 116 perform numerical simulation of physical response(s) during manufacturing such as by employing finite element analysis (FEA) (e.g., simulation of strain energy generated during manufacturing of the part using the fixture) or other physical simulation techniques to identify an optimal placement of one or more sensors 184 on and/or in the fixture 180 and/or on and/or in the physical structure 188. Note that (as used herein) “optimal” (or “optimization” or “optimum”) does not mean that the best of all possible designs (for the fixture or for the sensor placement) is achieved in all cases, but rather, that a best (or near to best) design is selected from a finite set of possible designs that can be assessed within an allotted time, given the available processing resources. In any case, the one or more sensors 184 can be used to collect data during manufacturing of the part and detect one or more issues with the manufacturing process, such as part deflection, fixture deflection, and chatter. Moreover, the sensor data can be fed back to alter and redefine an improved fixture design.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) or augmented reality (AR) system. For example, the input/output devices 118, 120 can include a VR/AR input controller 118a (or other input control device, such as a glove) and/or a VR/AR headset 120a.

The CAD program(s) 116 implement numerical simulation 132 of a manufacturing process to determine one or more physical responses (during manufacturing) of the fixture 180 and/or the physical structure 188 to be manufactured in order to improve a design of the fixture 180. Various types of numerical simulation 132 can be performed by the CAD program(s) 116 (locally and/or by remote procedure call) including FEA, dynamic, static, harmonic, Computational Fluid Dynamics (CFD), Acoustics/Noise Control, heat, and/or thermal conduction simulations. Also, various types of manufacturing can be simulated by the CAD program(s) 116 (locally and/or by remote procedure call) including welding, subtractive (e.g., milling), additive (e.g., SLS) and/or computational injection molding simulations. In some cases, process (e.g., with hand assembly) simulation can be used and/or simulation of wear or non-linear strain can be useful for determining the useable life time/durability of the fixture. Finally, factory/plant/facility simulation can be employed for multiple system integrations in some implementations.

The numerical simulation 132 generates simulated data for the one or more sensors 184, and the CAD program(s) 116 can use this simulated data to improve the design of the fixture 180 using a shape synthesis process, as noted above. For example, the shape synthesis process can change the shape of a portion 180A of the fixture 180, e.g., by thinning the fixture 180 in one direction while thickening the fixture 180 in another direction to adjust the harmonics of the fixture 180 to improve data quality for a load cell sensor 184. Note that the CAD program(s) 116 can also provide 3D modeling functions that give a user 190 direct control over the design of the fixture 180. In general, the CAD program(s) 116 can be used to build precise geometric descriptions of a three-dimensional (3D) model of the fixture 180, while physical simulations enable improved performance of that fixture 180 without time consuming physical testing.

The CAD program(s) 116 can provide user interface elements that enable the user to specify inputs for the physical simulation(s), such as materials and loading cases for the fixture 180, the physical structure 188 and/or the manufacturing process, where the loading cases define loads in different directions to be borne by the physical structure 188 and/or the fixture 180 during the manufacturing. Thus, the user 190 can interact with the UI 122 of the CAD program(s) 116, including producing a full mechanical problem definition for the fixture 180 to be used in manufacturing. In the example of FIG. 1, the fixture 180 is represented as a simple shape indicative of a soft jaw fixture, but the shapes and topologies of the fixtures that can be designed with the present systems and techniques can vary widely, depending on the specific physical structure and the manufacturing process therefor. Thus, many different types of fixtures can be redesigned using the described systems and techniques, including a fixture composed of holding tabs formed from a same workpiece out of which the part is milled (e.g., in a 5-axis tabbing workflow).

The design of the fixture 180 can be iteratively modified (e.g., using a generative design process, executed locally and/or by remote procedure call) which enables the CAD program(s) 116 to automatically redesign the fixture 180 based on design criteria, where the geometric design of the fixture 180 can be iteratively optimized based on feedback from simulated manufacturing. The design criteria can be defined by the user 190, or by another party and imported into the CAD program(s) 116, and/or the design criteria can be preprogrammed into the CAD program(s) 116. In any case, the final 3D model of the design of the fixture 180 (e.g., once the user 190 is satisfied with the design) can be stored in 3D model document(s) 130, e.g., in boundary representation (B-Rep) format. Note that various types of geometry representation can be used by the CAD program(s) 116, such as T-Spline, subdivision surface, mesh, and/or other computer 3D modeling formats, either in different implementations or in a single implementation.

The fixture 180 can itself be manufactured using an additive manufacturing (AM) machine 170 and/or a subtractive manufacturing (SM) machine 174. For example, the CAD program(s) 116 can generate from the 3D model document(s) 130 of the 3D model of the fixture 180 a document 160 (having a toolpath specification of an appropriate format) and provide the document 160 to the AM machine 170 and/or the SM machine 174, which can be directly connected to the computer 110, or connected via a network 140, to build the fixture 180. This can involve a post-process carried out on the local computer 110 or a cloud service to export the 3D model document(s) 130 to an electronic document from which to manufacture.

In addition, the user 190 can save or transmit the 3D model document(s) 130 for later use. Note that an electronic document (which for brevity will simply be referred to as a document) can be a file, but does not necessarily correspond to a file. A document may be stored in a portion of a file that holds other documents, in a single file dedicated to the document in question, or in multiple coordinated files.

The process of generating a document (having a toolpath specification of an appropriate format) to build the fixture 180 from its 3D model can also be used to generate a document (having a toolpath specification of an appropriate format) to build the physical structure 188 using the same or different manufacturing machinery used to build the fixture 180. The AM machine 170 can employ one or more additive manufacturing techniques, such as granular techniques (e.g., Powder Bed Fusion (PBF), Selective Laser Sintering (SLS) and Direct Metal Laser Sintering (DMLS)) or extrusion techniques (e.g., Fused Deposition Modeling (FDM), which can include metals deposition AM). In some cases, the AM machine 170 builds the physical object directly, and in some cases, the AM machine 170 builds a mold for use in casting or forging the physical object.

The SM machine 177 can employ one or more subtractive manufacturing techniques, such as milling, electrode discharge machining, chemical machining, waterjet machining, etc. The SM machine 174 can be a Computer Numerical Control (CNC) milling machine, such as a multi-axis, multi-tool milling machine. For example, the SM machine 174 can be a two or more axis CNC milling system (e.g., a 2-axis, 2.5-axis, 3-axis, 4-axis, 5-axis, or 6-axis milling machine) in a computer-controlled manufacturing system. In some implementations, the CAD program(s) 116 can generate CNC instructions for a machine tool system that includes multiple tools 174A (e.g., solid carbide round tools of different sizes and shapes, and insert tools of different sizes that receive metal inserts to create different cutting surfaces) useable for various machining operations. Moreover, the document 160 (which can also be referred to as a CNC numerical control (NC) program) can include a toolpath specification for performing roughing, semi-finishing and/or finishing operations during manufacturing.

While two general types of manufacturing machines are shown in FIG. 1, various different manufacturing systems and techniques can be employed, either alone or in combination, and the CAD program(s) 116 can include suitable algorithms to simulate the various types of manufacturing systems and techniques, and optionally, to generate an appropriate toolpath specification for one or more of these various manufacturing systems to manufacture a part using a fixture that has been designed using the systems and techniques described in this application. Moreover, as noted above, the simulated data generated during the numerical simulation 132 of the manufacturing using the fixture 180 can be used to improve the placement of the one or more sensors 184 to be used during that manufacturing.

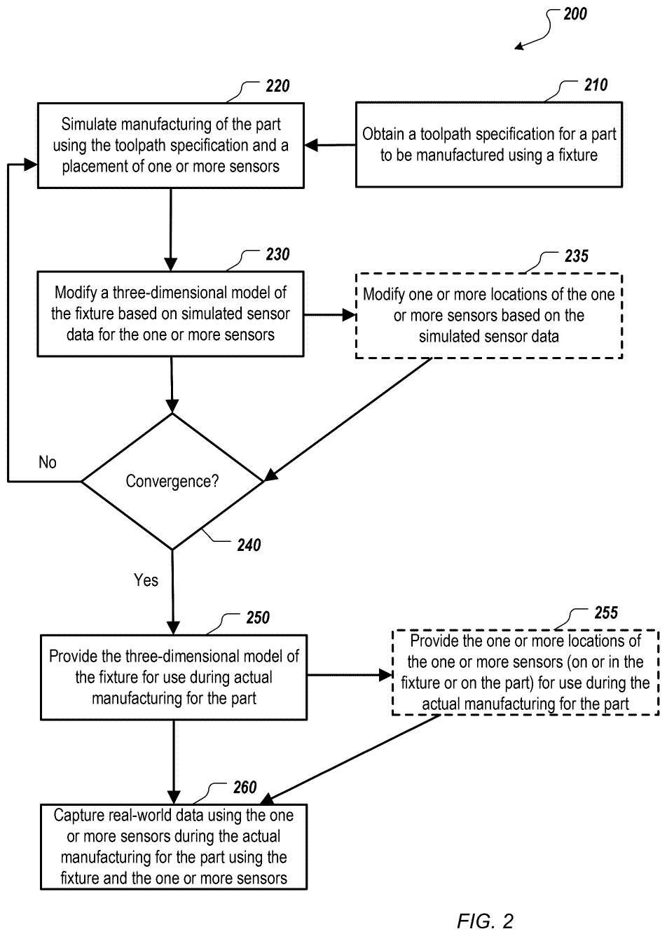

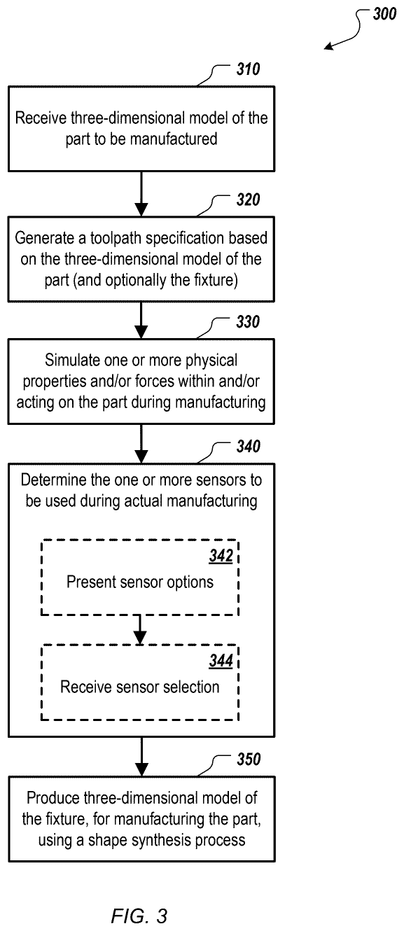

FIG. 2 shows examples of processes 200 (e.g., preformed by CAD program(s) 116, 3D modeling program(s) 904, and/or system 100) for designing a fixture, and optionally sensor placement, based on simulated manufacturing and sensor feedback. A toolpath specification for a part (or more generally, for a physical structure 188) to be manufactured by a computer-controlled manufacturing system using a fixture for the part is obtained 210. In some cases, this toolpath specification is the same toolpath specification that will be used during the actual manufacturing. In some cases, this toolpath specification is only used during simulated manufacturing, and a different toolpath specification is generated later once the fixture design has been completed. Moreover, in some cases, the obtaining 210 involves receiving the toolpath specification and an initial design of the fixture from another process or from the user, and in other cases, the obtaining 210 involves generating one or both of the toolpath specification and the initial design of the fixture, and optionally, determining the sensor(s) to be used (see the detailed description below in connection with FIG. 3).

Manufacturing of the part is simulated 220 using the toolpath specification and a placement of one or more sensors at one or more locations on and/or in the fixture and/or on and/or in the part. The initial placement of the one or more sensors can be generated automatically and/or based on user input. Further, the simulating 220 produces simulated data for the one or more sensors at the one or more locations in accordance with the placement.

The simulation 220 can generate data representing one or more physical properties and/or forces within and/or acting on the part and/or the fixture, in accordance with their respective 3D models, a selected manufacturing process (e.g., welding, milling, or additive manufacturing), and one or more constraints defined for the selected manufacturing process, to produce predicted physical properties and/or forces data. For example, the load(s) experienced by the fixture during the manufacturing process can be simulated 220 to determine the details of any movement of the fixture and/or the part during the manufacturing process, such as lateral and/or twisting or torsional movement of the fixture and/or the part. In general, the details of the simulation 220 will depend on the type of fixture 180.

Various different types of physical properties or forces can affect the manufacturing process, including temperature, thermal expansion, warping, melting and/or solidification, pressure, humidity, electric and/or electro-magnetic flux, vibration, natural frequency, buckling, warping, strain, torque, etc. Thus, the simulation 220 of physical properties can include, among other possibilities, simulating thermal (including rise and fall during manufacturing operations, such as welding, milling, drilling, boring, and turning, with or without coolant, that cause parts to grow or shrink), material solidification, part deflection (e.g., from milling, drilling, boring, etc.), loading (e.g., from tightening the part to the fixture or squeezing the part), buckling, natural frequency, and/or electric or electro-magnetic flux properties. Further, process (e.g., with hand assembly) simulation, wear and/or non-linear strain simulation (for determining the useable life time/durability of the fixture), and/or factory/plant/facility simulation (for multiple system integrations) can be employed in some implementations. Note that the setup for physical simulation(s) (e.g., the load case) will be different for different physical simulation(s).

A 3D model of the fixture is then modified 230 based on the simulated data to improve data quality for the one or more sensors at the one or more locations, to improve performance of the fixture, or both, during actual manufacturing of the part. In some implementations, the simulation 220 and modification 230 is an iterative sub-process that proceeds until convergence 240 on an optimal or near optimal design is achieved. The modification 230 involves using a shape synthesis process, and in some implementations, this shape synthesis process is a generative design process employing one or more boundary conditions, which can be governed by the physical properties and/or forces data determined during the simulating 220.

Since the exact location of each sensor on a fixture and the type of each sensor (e.g., manufacturer, shape, area, material, etc.) as well as the units of measurement and other environmental factors (e.g., temperature, pressure, humidity, etc. at the time of measurement) are known, this contextual information can be fed back into the simulation model to provide the simulation with further context so it can differentiate between fundamentally theorized data and actual real world data. Using this comparison, the simulation can correct itself, which in turn will alter a re-running of the generatively designed fixture. Thus, the simulated sensor feedback facilitates alteration of the automated fixture design to redefine the fixture so as to improve both the performance of the fixture and the quality of the data obtained from the sensor(s) during the actual manufacturing.

Once the redesign of the fixture is completed, the 3D model of the fixture is provided 250 for use during the actual manufacturing of the part by the computer-controlled manufacturing system using the fixture and the one or more sensors at the one or more locations, e.g., by the AM machine 170 and/or the SM machine 174 in FIG. 1. The providing 250 can involve storing or sending the final 3D model of the fixture for later use in creating instructions for manufacturing the fixture, and/or the providing 250 can include generating the instructions for manufacturing the fixture. The fixture can then be built and used during the actual manufacturing for the part, and real-world data can be captured 260 using the one or more sensors during the actual manufacturing for the part performed by the computer-controlled manufacturing system using the fixture and the one or more sensors at the one or more locations.

In addition, in some implementations, the simulation 220 includes the effects of the one or more physical sensors during the actual manufacturing, and the placement of these sensor(s) can also be optimized. For example, the type of sensor and its specific location can change the structural response of the fixture, e.g., heighten or dampen vibration on the fixture, influence temperature, etc. Thus, the simulating 220 the manufacturing of the part can include simulating 220 effects of the one or more sensors on the manufacturing in accordance with one or more predefined physical attributes of the one or more sensors and the placement of the one or more sensors.

Before (or after) the modifying 230 of the 3D model of the fixture, the one or more locations of the one or more sensors can be modified 235 based on the simulated data to improve data quality for the one or more sensors at the one or more locations, to improve performance of the fixture, or both, during actual manufacturing of the part. For example, depending on the identified type of force and boundary conditions (fixture wall thickness, location, threshold of force, etc.) a sensor can be placed at a peak load location to capture data during the actual manufacturing process. The sensor can be placed directly on the part or mounted directly on the fixture, e.g., in a fixed position or behind a flexure.

As a more detailed example, for a load cell sensor, the modification 235 can take account of an accuracy of measurement and a focal area of load on the load cell (is the load direction a constant directly on the center of the load cell measurement area or is the load direction skewed and/or dynamic) as determined during the simulation 220. Various deviations of direction at various loads can be simulated and used to create a “map” of possible loads at various locations on the sensor measurement area based on a particular placement. Using this information, it can be determined whether the location of the sensor is optimal and if the fixture design is performant or needs modification to increase performance (e.g., thickening to reduce load transferred to the fixture which will in turn reduce deflection, or more bracing, etc.). If the location is not optimal, the captured simulated map can be provided to the generative simulation to relocate the sensor and repeat until the placement is deemed satisfactory and/or optimal, improving both the sensor location and the fixture in the process.

In the case of a temperature sensor, most materials have some sort of thermal reaction, which causes changes in the size of the fixture and/or the part during temperature variations, which is often introduced as a byproduct of manufacturing processes. By simulating temperature sensor value variations that a placed temperature sensor can capture, possible variations in the part and/or fixture size can be analyzed by calculating the thermal expansion of the part and/or fixture using the thermal coefficient of expansion of the part and/or fixture, along with the simulated value(s) and material of the part and/or fixture. With this determined growth (movement) of the part and/or fixture at different simulated temperature values, it can be determined how this will impact several factors of the fixture, such as locations of key features, deflection, etc. These values can then be used to check and correct geometry that may not be optimal for differing temperatures and manufacturing environments, thus improving the design of the fixture.

With respect to vibration, one or more sensors can be used to not only measure the vibration but to actually change the natural resonance of the part in the fixture by adjusting the sensor placement so as to dampen a frequency or vibration within the fixture during the manufacturing process. When machining a part (especially a part with tight tolerances) the natural resonance of the material, the machine, the tool and the part can be taken into account. Using the known resonance of the machine, the tool, and the material, the fixture can be detuned so that the natural resonance of the part can be counteracted by the way the part is held by the fixture. Thus, the resonance that will likely occur during manufacturing can be simulated both before and after one or more sensors are added, and the location(s) of the sensor(s) can be changed until the resonance is still within a certain percentage of (or less than) the resonance that occurs without the sensor(s). By inserting known sensor(s) and by either moving a sensor into direct contact with the part or by putting a sensor behind a flexure, a dampening body, etc., the resonance of the part and the fixture can be changed. While the change in resonance may be small, it can nonetheless increase the surface finish and reduce the risk of resonance induced machining issues, thereby producing better parts and higher quality sensor data during the manufacturing process.

Once the redesign of the fixture and of the sensor placement is completed, the one or more locations of the one or more sensors can be provided 255 for use during the actual manufacturing for the part by the computer-controlled manufacturing system using the fixture and the one or more sensors at the one or more locations, e.g., by the AM machine 170 and/or the SM machine 174 in FIG. 1. The providing 255 can involve storing or sending the sensor placement for later use in creating instructions for placing the sensor(s) on and/or in the fixture and/or on and/or in the part before the actual manufacturing of the part begins, and/or the providing 255 can include generating the instructions for placing the sensor(s) before the actual manufacturing of the part begins.

FIG. 3 shows examples of processes 300 (e.g., preformed by CAD program(s) 116, 3D modeling program(s) 904, and/or system 100) that initially creates a fixture and optionally determines one or more sensors for the fixture. A 3D model of the part is received 310, and a toolpath specification is generated 320 based on the 3D model of the part, and optionally based on the 3D model of the fixture. Note that, in most cases, producing 350 the initial 3D model of the fixture is done after generation 320 of the toolpath specification for the part and is based on the generated toolpath specification for the part, but in some cases, the producing 350 occurs before the generation 320, or the initial 3D model of the fixture can be provided as an input in some implementations. Moreover, in some implementations, the generation 320 and the production 350 are an iterative process in which the manufacturing plan for the part is revised in light of the modifications to the fixture design, and vice versa.

In any case, the 3D model of the fixture is produced 350 using a shape synthesis process. This shape synthesis process can be a generative design process that employs one or more boundary conditions (e.g., loading conditions) to govern shape modifications, or this shape synthesis process can be an automated modeling process with no predefined boundary conditions. However, in some cases, defining a boundary condition will be beneficial, at least in order to constrain the overall size and mounting options for the fixture given a planned manufacturing application.

Further, in some implementations, the sensor(s) to be used during the actual manufacturing are determined based on an initial simulation of the manufacturing. Thus, one or more physical properties and/or forces within and/or acting on the part can be simulated 330 in accordance with the 3D model of the part, a selected manufacturing process (e.g., welding, milling, or additive manufacturing), and one or more constraints defined for the selected manufacturing process, to produce predicted physical properties and/or forces data, such as described in further detail above. The one or more sensors to be used during the actual manufacturing of the part can then be determined 340 in accordance with the predicted physical properties and/or forces data. For example, the determining 340 can involve presenting 342 options for two or more pre-defined sensor packages corresponding to two or more failure modes (e.g., chatter, part shift, etc.) as discussed further below, and receiving 344 a selection of at least one of the two or more pre-defined sensor packages to determine the one or more sensors to be used during the actual manufacturing for the part.

Moreover, the producing 350 of the 3D model of the fixture can be based on the one or more sensors and the predicted physical properties and/or forces data. Note that the simulating 330 can be done to generate the predicted physical properties and/or forces data for the producing 350 regardless of whether or not the determining 340 is done using that same data. Other variations of the process operations are also possible since the generation of the toolpaths used for manufacturing simulation can be dependent on the sensor placement and the sensor placement can be dependent on the toolpaths generated for manufacturing simulation. For example, in some cases, the toolpaths are generated 320 first and then the fixture's 3D model is produced 350, which means the sensor placement will be more dependent on loads simulated for manufacturing using the toolpath and simulated sensor feedback.

In contrast, when the fixture's 3D model is produced 350 before the toolpaths are generated 320, the toolpaths can be generated 320 based on expected areas of highest risk (e.g., force applied, temperature concentration, thin bodies, etc.) and simulated sensor feedback. In view of these interdependencies, in some implementations, the processes 300 are designed as a closed and iterative cycle to determine the optimal sensor location, where sensor location can affect toolpaths and toolpaths can affect sensor location. Moreover, in some implementations, the options for the two or more pre-defined sensor packages that are presented 342 will depend on the predicted physical properties and/or forces data from the simulation 330, and in some implementations, the user is able to add customized sensor packages at their own discretion.

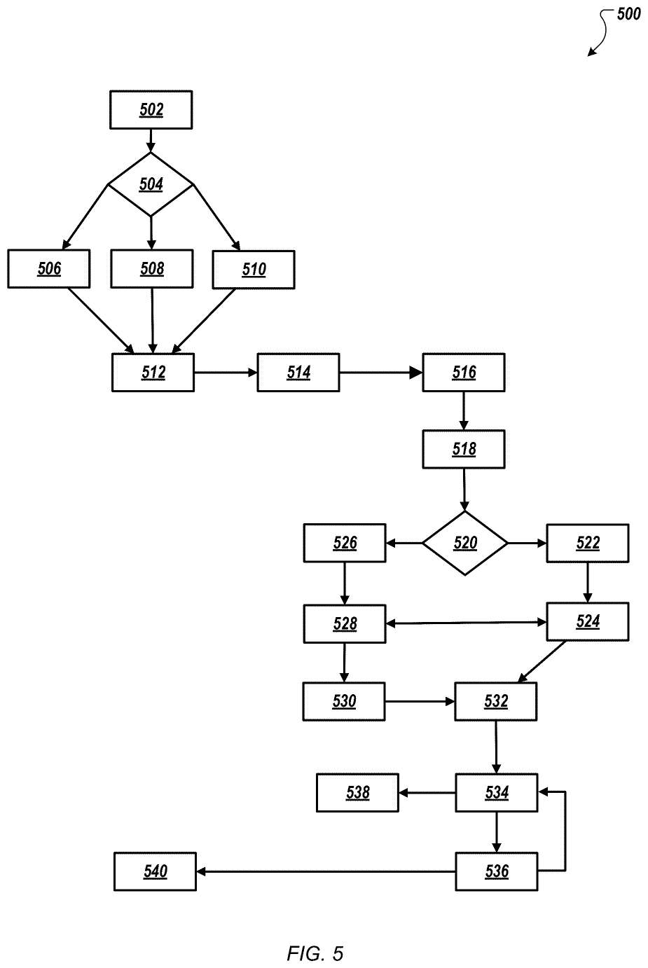

FIG. 5 shows an example of processes 500 (e.g., preformed by CAD program(s) 116, 3D modeling program(s) 904, and/or system 100) that add sensor(s) for a fixture and then modifies the fixture based on simulated loads and sensor feedback. A CAD model of a part can be obtained 502 (e.g., generated based on user input, received from another program or system, or loaded from persistent storage). A manufacturing process can be selected 504. In this example, three manufacturing processes are provided as options: welding 506, milling 508, and additive manufacturing 510. However, it will be appreciated that more, fewer, and/or different manufacturing processes can be supported in various implementations.

One or more constraints can then be defined 512 based on the selected manufacturing method. These constraint(s) can be pre-programed into the software, provided by user input, loaded or received from another program or system, or a combination thereof. In some cases the constraint(s) can be specific to a particular manufacturing machine to be used, e.g., a rigid versus less rigid machine, a thermally managed versus non-thermally managed machine, and/or any coolant types/processes used (e.g., MQL (minimum quality lubricant) cooling, flood cooling, oil cooling, alcohol cooling, etc.). In some implementations, constraint(s) can include tool material (e.g., carbide versus high-speed steel (HSS) cutting tools), one or more properties (e.g., stick-out), fixture material, part material, etc. In any case, the forces acting against the part can be simulated 514 in accordance with the defined manufacturing constraint(s), and one or more sensors can be added 516 on and/or in the fixture, on and/or in the part, or a combination thereof.

In some implementations, the sensor(s) that are added 516 are determined based on the predicted physical properties and/or forces data from the simulation 514. This can be an automated (or partially automated) process in which the program selects sensor(s) and/or selects an initial sensor placement based on simulated forces for the selected manufacturing method. This can include manual selection of sensor(s) and sensor placement, e.g., where the user is shown the predicted physical properties and/or forces data from the simulation 514 on the display device and can use this displayed information to inform sensor selection and placement. In any case, sensors can be inserted into the design of the fixture using the results of the simulation 514.

In some implementations, the sensor(s) that are added 516 are determined by user selection of a predefined sensor package that is then inserted into the design of the fixture in order to detect a specified type of failure during manufacturing. Thus, a user option to select a pre-defined sensor package (e.g., a single sensor or a cluster of sensors, which can be of the same or different types) can be provided.

A sensor package is a pre-formulated set of one or more sensors designed to detect a specific failure mode for the selected manufacturing process, such as chatter, part shift, etc. For example, failure modes and proposed sensors can include those shown in Table 1 below.

TABLE 1

| Failure Mode | Sensor Type |
|---|---|
| Chatter Vibration | Load Cell |
| Chatter Resonance | Piezo Knock Sensor |
| Chatter Harmonics | Load Cell or Piezo Electric Sensor |
| Part Shift | N Load Cells (usable for part |
| | positioning and/or part movement) |
| Part Lift | Load Cell or Light Sensor |
| Part Resonance | Piezo Electric Sensor |
| Expansion | Load Cell or Piezo Electric Sensor |
| Relieving Forces | Load Cell or Piezo Electric Sensor |
| Twist | Load Cell or Piezo Electric Sensor |
| Over-Clamping | Load Cell or Piezo Electric Sensor |
| Under-Clamping | Load Cell or Piezo Electric Sensor |
| Heat | Thermal Sensor |

Various other failure modes and types of sensors are possible in various implementations in light of the different manufacturing processes that are supported by a given implementation.

In general, the sensor selection can be a manual selection, an automated selection, or a combination thereof. The automated sensor selection can be based on results of the numerical simulation of the manufacturing process (e.g., based on forces alone) with no specific failure mode being considered, or the automated sensor selection can be optimized for one or more specific failure modes (e.g., as selected by the user and/or as indicated by the selected manufacturing process and the one or more defined constraints). In addition, the sensor selection can be based on (e.g., optimized for) the results of an initial numerical simulation of the manufacturing process.

A 3D model of the fixture can be generatively designed 518 based on the selected sensor package. A decision can be made 520 regarding how to define the sensor placement. Sensor placement can be automated, manual, or a combination thereof. Automated sensor placement 522 can include locating 524 a sensor in direct contact with the part, locating 528 a sensor with a flexture between the part and the sensor, inserting 530 a known flexture and/or load release, or a combination thereof. Manual sensor placement 526 can include locating 528 a sensor with a flexture between the part and the sensor, inserting 530 a known flexture and/or load release, locating 524 a sensor in direct contact with the part, or a combination thereof. Note that a “flexture” is a structural portion of the fixture and/or a structural component that is attached to the fixture or the part, and that is designed to flex in a pre-defined manner (e.g., with only a single compliant degree of freedom) in response to physical forces.

Referring again to FIGS. 1 & 2, many different types of sensors 184 can be used. In some cases, the one or more sensors 184 include a load cell comprising a flexture (e.g., an aluminum bodied flexture), and modifying 230 the 3D model of the fixture 180 includes changing a shape of the fixture 180 at a location of the flexture to cause the fixture 180 to flex in a specific direction to improve data quality from the load cell. For example, in some cases, the fixture 180 can be modified (or “tuned”) to operate as (or facilitate the use of) a flexture by thinning the fixture 180 in one direction while thickening the fixture 180 in another direction to provide a single degree of freedom for flex that will then be detected by the load cell, while the fixture 180 remains fixed and unmoving in directions orthogonal to that single degree of freedom. Note that different parts of the fixture 180 can be designed to flex in different directions, and a separate sensor can be used to detect flex of the fixture in each of those different directions. In some cases, each fixture 180 is treated like a load cell that needs to be tuned so one can understand the forces acting on the part during manufacturing while the fixture still holds the part steady enough for manufacturing.

In some cases, the one or more sensors 184 include a vibration sensor, modifying 235 the one or more locations includes moving the vibration sensor to change a natural resonance of the part in the fixture 180, and modifying 230 the 3D model of the fixture 180 includes changing a shape of the fixture 180 to detune the fixture 180 such that the natural resonance is counteracted by a manner in which the fixture 180 holds the part during the actual manufacturing of the part. Further, if additional failure modes are expected, the process can be reversed, and measured data and simulation can be used to identify sensor placement and then the manufacturing process can be modified to better revise or monitor the placement. Note that one measurement may affect another measurement, i.e., vibration ranges may affect temperature variation or vice versa, so a happy middle ground can be calculated.

In some cases, the one or more sensors 184 include a temperature sensor. In this or other cases, modifying 230 the 3D model of the fixture 180 can include changing a shape of the fixture 180 to account for thermal expansion of the fixture 180, or of the part, to improve performance of the fixture 180 during the actual manufacturing of the part. Further, the modifying 230 can include adding feature(s) to the fixture 180 to reduce or add heat at a specific point in relation to the one or more sensors 184 to thermally stabilize the fixture 180, prolong its useable life, increase fixture durability, and/or increase accuracy of the fixture 180. Other sensor types and/or modifications of fixtures and sensor locations are also possible.

Referring again to FIG. 5, note that the process 500 can involve an initial automated sensor placement 522 followed by user adjustments of that initial placement through the UI of the program. In any case, upon user approval 532, the process 500 continues with a full manufacturing simulation and fixture modification in accordance with that manufacturing simulation. Thus, loads on various portions of the fixture and sensor feedback (in accordance with the sensor locations) can be simulated 534, and modification 536 of the fixture design can iterate with the simulation 534 until a pre-defined condition is satisfied for the fixture and the sensor data to be provided during actual manufacturing. In some implementations, one or more pre-defined condition to be satisfied can include user defined rulings (e.g., a maximum number of iterations condition, a time investment condition (stop after x amount of hours of refinement), etc.), improvement threshold(s) (e.g., a performance index or calculation of an improvement percentage based on one or more tracked characteristics of fixture such has rigidity, thermal efficiency, etc.), and/or cost of the simulation/fixture to be made.

During the simulation 534, simulated sensor data can be captured 538 for comparison to actual data. In addition, once the iterations between simulation 534 and modification 536 is completed, a completed fixture design can be output 540 for use in manufacturing for the part, potentially after further modifications by the user, as desired. Note that the process 500 is but one example of an implementation of the present systems and techniques. Other approaches to sensor selection, placement, and fixture design are also possible.

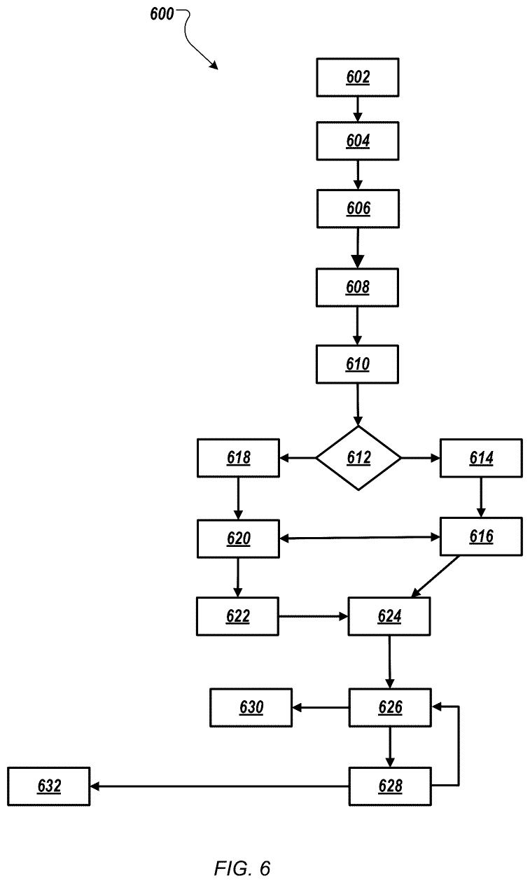

For example, FIG. 6 shows a process 600 (e.g., preformed by CAD program(s) 116, 3D modeling program(s) 904, and/or system 100) that defines a moving and static jaw on a softjaw fixture. A CAD model of a part can be obtained 602 (e.g., generated based on user input, received from another program or system, or loaded from persistent storage). A clamping location on the part can be defined 604 (e.g., manually by the user, automatically by the program, or a combination thereof). A direction of clamping load can be chosen 606 (e.g., manually by the user, automatically by the program, or a combination thereof). A direction of machining force can be chosen 608 (e.g., manually by the user, automatically by the program, or a combination thereof). Then, a 3D model of the fixture (soft jaw) can be generatively designed 610 based on the part, the clamping location, the direction of clamping load, and the direction of machining force.

With the initial design of the fixture (soft jaw) completed, the process 600 can proceed in a similar manner as process 500. A decision can be made 612 regarding how to define the sensor placement. Sensor placement can be automated, manual, or a combination thereof. Automated sensor placement 614 can include locating 616 a sensor in direct contact with the part, locating 620 a sensor with a flexture between the part and the sensor, inserting 622 a known flexture and/or load release, or a combination thereof. Manual sensor placement 618 can include locating 620 a sensor with a flexture between the part and the sensor, inserting 622 a known flexture and/or load release, locating 616 a sensor in direct contact with the part, or a combination thereof.

As with the process 500, the process 600 can involve an initial automated sensor placement 614 followed by user adjustments of that initial placement through the UI of the program. In any case, upon user approval 624, the process 600 continues with a full manufacturing simulation and fixture modification in accordance with that manufacturing simulation. Thus, loads on various portions of the fixture and sensor feedback (in accordance with the sensor locations) can be simulated 626, and modification 628 of the fixture design can iterate with the simulation 626 until a pre-defined condition is satisfied for the fixture (soft jaw) and the sensor data to be provided during actual manufacturing. Further, in some implementations, one or more pre-defined condition to be satisfied can include user defined rulings (e.g., a maximum number of iterations condition, a time investment condition (stop after x amount of hours of refinement), etc.), improvement threshold(s) (e.g., a performance index or calculation of an improvement percentage based on one or more tracked characteristics of fixture such has rigidity, thermal efficiency, etc.), and/or cost of the simulation/fixture to be made.

During the simulation 626, simulated sensor data can be captured 630 for comparison to actual data. In addition, once the iterations between simulation 626 and modification 628 is completed, a completed fixture design can be output 632 for use in manufacturing the part, potentially after further modifications by the user, as desired. Further, the simulated data that is captured 538,630 can be used in various manners.

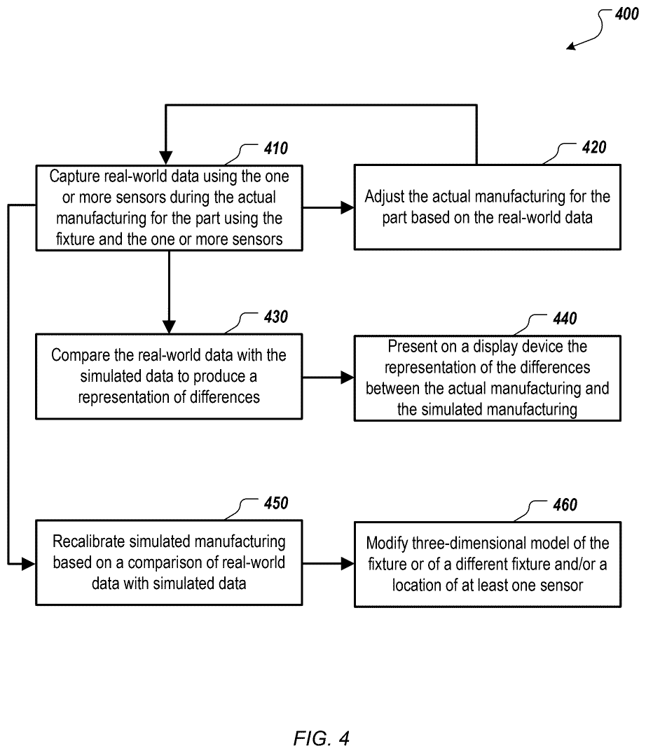

FIG. 4 shows examples of processes 400 (e.g., preformed by CAD program(s) 116, 3D modeling program(s) 904, and/or system 100) that recalibrate simulated manufacturing for fixture design, effect a fixture digital twin, and/or adjust a manufacturing process based on real-world data captured using one or more sensors on (or in) the fixture during manufacturing for a part using the fixture. Real-world data can be captured 410 using one or more sensors during actual manufacturing for a physical structure (e.g., a part) by the computer-controlled manufacturing system using a fixture and the one or more sensors at one or more locations. In some implementations, the actual manufacturing for the physical structure by the computer-controlled manufacturing system can be adjusted 420 based on the real-world data, as that data is captured and/or in a future manufacturing run using the fixture.

The adjusting 420 can include changing toolpath parameters, such as feeds and speeds for a milling tool, and/or other modifications of the manufacturing process. Various approaches to active adjustment of the manufacturing process in view of an optimized fixture and sensor placement for specific types of sensors can be performed. For example, for a load cell sensor, the real-world captured data (e.g., a live stream during the manufacturing process) can be used to alter toolpaths and/or other aspects of control of the manufacturing process to compensate for measured deflection, making more accurate parts and thereby improving the actual manufacturing process. For the example of a temperature sensor, the real-world captured data (e.g., a live stream during the manufacturing process) can be used to provide real-time intelligence to the status of the fixture and/or part and be used to compensate for measured temperature variations, making more accurate parts and thereby improving the actual manufacturing process.

Note that there can be variables for the actual manufacturing that cannot be accounted for at design time, e.g., sharpness of an endmill and material voids, or defects in the material of the fixture or the part since every lot/piece of material can be variable. Thus, by using sensor feedback and adjusting the manufacturing process as it is occurring, the manufacturing process can be adjusted to make output as similar as possible to the prior simulation in order to provide the best possible manufacturing results.

Further, in some implementations, the simulated manufacturing can be recalibrated 450 based on a comparison of the real-world data with the simulated data to produce a recalibrated manufacturing simulation process. Note that this recalibration 450 of the simulation can be for the currently used fixture, e.g., a first manufacturing run with fixture can provide data that is then fed back into the system to update the design of the fixture, and/or for future fixtures design using the present systems and techniques, e.g., the fixture design process can automatically improve over time as more comparison data from actual manufacturing is captured during manufacturing runs that use a fixture designed as described in this specification. Even when the part and the fixture are different, the conditions of the manufacturing process can be similar, and so the real-world data from one manufacturing run can be used provide more accurate context information, thereby improving the manufacturing simulation process through this recalibration 450. Thus, the 3D model of the current fixture or a different 3D model of a different fixture and/or a location of at least one sensor for the fixture or for the different fixture can be modified 460 using the recalibrated manufacturing simulation process.

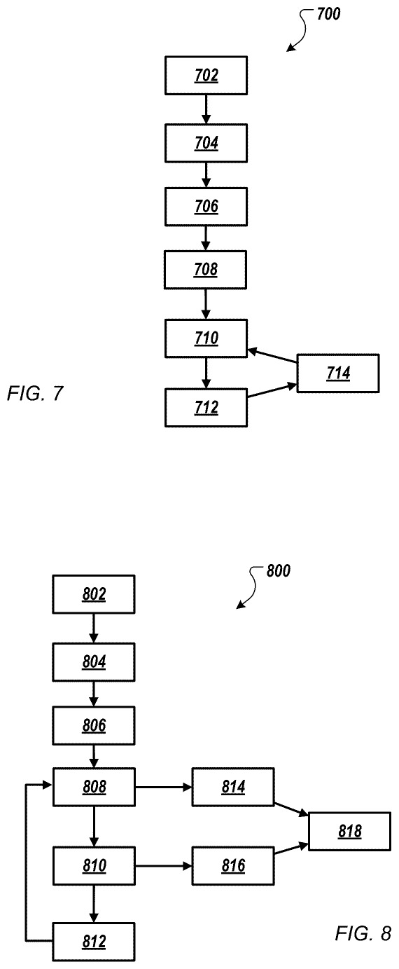

FIG. 7 shows an example of a process 700 (e.g., preformed by CAD program(s) 116, 3D modeling program(s) 904, and/or system 100) that calibrates an automated fixture design process. The designed fixture can be obtained 702 (e.g., manufactured or received). The fixture can be positioned for use 704 with a computer-controlled manufacturing system (e.g., a 2.5-axis or 3-axis milling machine). One or more calibrated sensors can be inserted 706. Then, the actual manufacturing process begins.

Data from the one or more calibrated sensors can be captured 708. The data from the one or more calibrated sensors can be compared 710 against the data from the prior simulation of the manufacturing process using the designed fixture and the one or more sensors. The comparison of the real-world data against the simulation data can be used to recalibrate 712 the simulation and/or to modify the fixture to more closely correspond to the real-world manufacturing of the physical structure using that fixture. Material can be added to or removed from 714 the fixture, adjustments can be made to sensor placement, or both. A new manufacturing simulation can then be performed and another comparison 710 against the real-world data can be performed. Note that this can be an iterative process performed using a single run of the actual manufacturing process (as shown) and/or an iterative process that involves more than one fixture design with sensor placement, plus more than one actual manufacturing run.

Returning again to FIG. 4, in some implementations, the real-world data is compared 430 with the simulated data to produce a representation of differences between the actual manufacturing and the simulated manufacturing. This representation of the differences between the actual manufacturing and the simulated manufacturing can be presented 440 on a display device (a display device that is local to the manufacturing equipment and/or a remote display device, such as in a mobile device). This presentation of information provides a digital twin of the manufacturing process that enables the user of the manufacturing equipment to readily see if the actual manufacturing is proceeding as expected, and take corrective actions as needed.

FIG. 8 shows an example of a process 800 (e.g., preformed by CAD program(s) 116, 3D modeling program(s) 904, and/or system 100) that creates an as-built fixture for a digital twin. The designed fixture can be obtained 802 (e.g., manufactured or received). The fixture can be positioned for use 804 with a computer-controlled manufacturing system (e.g., a 2.5-axis or 3-axis milling machine). One or more calibrated sensors can be inserted 806. Then, the actual manufacturing process begins.

Data from the one or more calibrated sensors can be captured 808. This data can provide 814 a real-world digital twin representation of the fixture with a live sensor feed, which can provide live, real-time data visualization feedback from the fixture. Further, the data from the one or more calibrated sensors can be compared 810 against the data from the prior simulation of the manufacturing process using the designed fixture and the one or more sensors. This simulation data can provide 816 a simulated digital twin representation of the fixture with the simulated sensor feedback. The respective digital twins can be overlayed 818 with other, e.g., on a display device, to view the differences between the simulated manufacturing and the actual manufacturing process for a specific physical structure that is built with that manufacturing process. Moreover, the comparison of the real-world data against the simulation data can be used to recalibrate 812 the simulation and/or to modify the fixture to more closely correspond to the real-world manufacturing of the physical structure using that fixture, as described above.

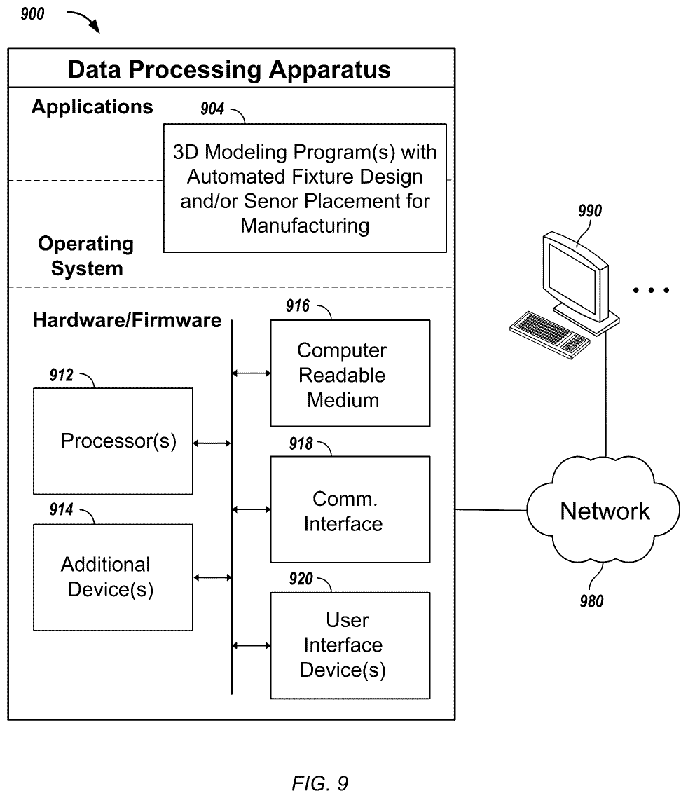

FIG. 9 is a schematic diagram of a data processing system including a data processing apparatus 900, which can be programmed as a client or as a server. The data processing apparatus 900 is connected with one or more computers 990 through a network 980. While only one computer is shown in FIG. 9 as the data processing apparatus 900, multiple computers can be used. The data processing apparatus 900 includes various software modules, which can be distributed between an applications layer and an operating system. The number of software modules used can vary from one implementation to another. Moreover, the software modules can be distributed on one or more data processing apparatus connected by one or more computer networks or other suitable communication networks.

The software module(s) can include executable and/or interpretable software programs or libraries, including tools and services of one or more 3D modeling programs 904 that implement the systems and techniques described above, including automated fixture design and/or sensor placement for use in one or more actual manufacturing processes. For example, a generative design process can be used to create a fixture, and the simulated manufacturing using the fixture can be used to validate and predict expected loads on specific points of the fixture. One or more flexures can be inserted with known characteristics along with one or more sensors to measure flexure movements in order to measure and distinguish between expected versus actual machining forces while machining a part.

The 3D modeling program(s) 904 can be CAD program(s) 904 (such as CAD program(s) 116) that implement manufacturing control operations (e.g., generating and/or applying toolpath specifications to effect manufacturing using the fixture and the one or more placed sensors). For example, the difference between expected machining forces and measured forces can be used to identify increased or reduced loads while machining a part. These observations can be used to identify part movement or machining issues while they happen. This approach can also prevent over/under tightening of a part in a fixture, such as by measuring linear movement in a fixture.

With enough sensors and simulated loads, any expected degrees of freedom in a part during manufacturing can be measured. Additionally, since linear movement in a flexure can be correlated with a translation, any unexpected linear translations during the manufacturing process can be used to understand a part's new position in space based on the other sensor readings. This can be done by triangulating three sensors that correlate to X, Y and Z direction in space or by adding additional sensors to measure additional degrees of freedom. This combination of sensor data and fixture design automation can enable full adaptive machining where there is feedback from the part as it is machined. Thus, by triangulating a part in space while machining, the part can be dynamically repositioned on the machine or in the fixture, such as by heating, cooling or compressing the fixture. A piezoelectric sensor can be used to fill both rolls by reading position as the fixture is compressed or by compressing the fixture when voltage is fed back into it.

The data processing apparatus 900 also includes hardware or firmware devices including one or more processors 912, one or more additional devices 914, a computer readable medium 916, a communication interface 918, and one or more user interface devices 920. Each processor 912 is capable of processing instructions for execution within the data processing apparatus 900. In some implementations, the processor 912 is a single or multi-threaded processor. Each processor 912 is capable of processing instructions stored on the computer readable medium 916 or on a persistent storage device such as one of the additional devices 914. The data processing apparatus 900 uses the communication interface 918 to communicate with one or more computers 990, for example, over the network 980. Examples of user interface devices 920 include a display, a camera, a speaker, a microphone, a tactile feedback device, a keyboard, a mouse, and VR and/or AR equipment. The data processing apparatus 900 can store instructions that implement operations associated with the program(s) described above, for example, on the computer readable medium 916 or one or more additional devices 914, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments can be implemented, such as AEC (Architecture, Engineering and Construction) program(s) embodiments that determine sensor placement on a structure and/or a design of the structure (where the structure can be created as part of a building and/or be used as a fixture for holding or supporting a portion of a building to be constructed) for use during construction and/or operation of a building. Furthermore, other embodiments are within the scope of the following claims. For example, the actions recited in the claims can be performed in a different order and still achieve desirable results.

### Examples

Although the present application is defined in the attached claims, it should be understood that the present invention can also (additionally or alternatively) be defined in accordance with the following examples.

Example 1: a method comprising:
obtaining a toolpath specification to be used in a manufacturing process for a physical structure in a computer-controlled manufacturing system using a fixture to hold the physical structure;
simulating the manufacturing process using the toolpath specification and a placement of one or more sensors at one or more locations on and/or in the fixture and/or on and/or in the physical structure, wherein the simulating produces simulated data for the one or more sensors at the one or more locations in accordance with the placement;
modifying a three-dimensional model of the fixture based on the simulated data to improve (i) data quality for the one or more sensors at the one or more locations, and/or (ii) performance of the fixture, during the manufacturing process; and
providing the three-dimensional model of the fixture for use during the manufacturing process performed by the computer-controlled manufacturing system using the fixture and the one or more sensors at the one or more locations, or using at least one of the one or more sensors at at least one of the one or more locations.

Example 2: the method of Example 1, wherein the obtaining comprises:
receiving a three-dimensional model of the physical structure;
generating the toolpath specification based on the three-dimensional model of the physical structure; and
producing the three-dimensional model of the fixture using a shape synthesis process.

Example 3: the method of Example 2, wherein the obtaining comprises:
simulating one or more physical properties and/or forces within and/or acting on the physical structure in accordance with the three-dimensional model of the physical structure, the manufacturing process, and one or more constraints defined for the manufacturing process, to produce predicted physical properties and/or forces data; and
determining the one or more sensors to be used during the manufacturing process for the physical structure;
wherein the producing comprises producing the three-dimensional model of the fixture based on the one or more sensors and the predicted physical properties and/or forces data.

Example 4: the method of any one of Examples 1-3, comprising determining the one or more sensors to be used during the manufacturing process for the physical structure based on predicted physical properties and/or forces data.

Example 5: the method of any one of Examples 1-4, wherein determining the one or more sensors to be used comprises:
presenting options for two or more pre-defined sensor packages corresponding to two or more failure modes for the manufacturing process; and
receiving a selection of at least one of the two or more pre-defined sensor packages to determine the one or more sensors to be used during the manufacturing process for the physical structure.

Example 6: the method of any one of Examples 1-5, wherein the computer-controlled manufacturing system comprises a two or more axis CNC milling system, the fixture is a soft jaw fixture, and the obtaining comprises:
determining a clamping location on the physical structure based on the three-dimensional model of the physical structure;
selecting a direction of clamping load at the clamping location;
selecting a direction of machining force to be applied to the physical structure; and
producing the three-dimensional model of the fixture based on the clamping location, the direction of the clamping load, and the direction of the machining force.

Example 7: the method of any one of Examples 1-6, wherein simulating the manufacturing process includes simulating effects of the one or more sensors on the manufacturing process in accordance with one or more predefined physical attributes of the one or more sensors and the placement of the one or more sensors, and the method comprises:
modifying the one or more locations of the one or more sensors based on the simulated data to improve (i) data quality for the one or more sensors at the one or more locations, and/or (ii) performance of the fixture, during actual manufacturing of the physical structure; and
providing the one or more locations of the one or more sensors for use during the manufacturing process for the physical structure performed by the computer-controlled manufacturing system using the fixture and the one or more sensors at the one or more locations.

Example 8: the method of Example 7, wherein the one or more sensors comprise a load cell comprising a flexture, and modifying the three-dimensional model of the fixture comprises changing a shape of the fixture at a location of the flexture to cause the fixture to flex in a specific direction to improve data quality from the load cell.

Example 9: the method of Example 7 or Example 8, wherein the one or more sensors optionally comprise a temperature sensor, and modifying the three-dimensional model of the fixture comprises changing a shape of the fixture to account for thermal expansion of the fixture, or of the physical structure, to improve performance of the fixture during the manufacturing process for the physical structure.

Example 10: the method of any one of Examples 7-9, wherein the one or more sensors comprise a vibration sensor, modifying the one or more locations comprises moving the vibration sensor to change a natural resonance of the physical structure in the fixture, and modifying the three-dimensional model of the fixture comprises changing a shape of the fixture to detune the fixture such that the natural resonance is counteracted by a manner in which the fixture holds the physical structure during the manufacturing process for the physical structure.

Example 11: the method of any one of Examples 1-10, comprising:
capturing real-world data using the one or more sensors during the manufacturing process for the physical structure performed by the computer-controlled manufacturing system using the fixture and the one or more sensors at the one or more locations.

Example 12: the method of Example 11, comprising:
recalibrating simulated manufacturing based on a comparison of the real-world data with the simulated data to produce a recalibrated manufacturing simulation process; and
modifying the three-dimensional model of the fixture or a different three-dimensional model of a different fixture and/or modifying a location of at least one sensor for the fixture or for the different fixture using the recalibrated manufacturing simulation process.

Example 13: the method of Example 11 or Example 12, comprising:
comparing the real-world data with the simulated data to produce a representation of differences between the manufacturing process and simulated manufacturing; and
presenting on a display device the representation of the differences between the manufacturing process and the simulated manufacturing.

Example 14: the method of any one of Examples 11-13, comprising:
adjusting the manufacturing process for the physical structure performed by the computer-controlled manufacturing system based on the real-world data.

Example 15: the method of any one of Examples 1-14, wherein the computer-controlled manufacturing system comprises a two or more axis CNC milling system, the manufacturing process for the physical structure comprises milling of the physical structure out of a workpiece, and the fixture comprises holding tabs formed from the workpiece during the milling of the physical structure out of the workpiece.

Example 16: a non-transitory computer-readable medium tangibly encoding a computer program operable to cause data processing apparatus to perform operations in accordance with the method of any one of Examples 1-15.

Example 17: a system comprising:
a computer-controlled manufacturing system;
a data processing apparatus including at least one hardware processor; and
a non-transitory computer-readable medium encoding instructions configured to cause the data processing apparatus to perform operations in accordance with the method of any one of Examples 1-15.

Example 18: the system of Example 17, wherein the computer-controlled manufacturing system comprises a two or more axis CNC milling system.

What is claimed is:

1. A method comprising:
obtaining a toolpath specification to be used in a manufacturing process for a physical structure in a computer-controlled manufacturing system using a fixture to hold the physical structure;
simulating the manufacturing process using the toolpath specification and a placement of one or more sensors at one or more locations on and/or in the fixture and/or on and/or in the physical structure, wherein the simulating produces simulated data for the one or more sensors at the one or more locations in accordance with the placement;
modifying a three-dimensional model of the fixture based on the simulated data to improve (i) data quality for the one or more sensors at the one or more locations, and/or (ii) performance of the fixture, during the manufacturing process; and
providing the three-dimensional model of the fixture for use during the manufacturing process performed by the computer-controlled manufacturing system using the fixture and the one or more sensors at the one or more locations.

2. The method of claim 1 wherein the obtaining comprises:
receiving a three-dimensional model of the physical structure;
generating the toolpath specification based on the three-dimensional model of the physical structure; and
producing the three-dimensional model of the fixture using a shape synthesis process.

3. The method of claim 2, wherein the obtaining comprises:
simulating one or more physical properties and/or forces within and/or acting on the physical structure in accordance with the three-dimensional model of the physical structure, the manufacturing process, and one or more constraints defined for the manufacturing process, to produce predicted physical properties and/or forces data; and
determining the one or more sensors to be used during the manufacturing process for the physical structure;
wherein the producing comprises producing the three-dimensional model of the fixture based on the one or more sensors and the predicted physical properties and/or forces data.

4. The method of claim 3, wherein the determining comprises determining the one or more sensors to be used during the manufacturing process for the physical structure based on the predicted physical properties and/or forces data.

5. The method of claim 3, wherein the determining comprises:
presenting options for two or more pre-defined sensor packages corresponding to two or more failure modes for the manufacturing process; and
receiving a selection of at least one of the two or more pre-defined sensor packages to determine the one or more sensors to be used during the manufacturing process for the physical structure.

6. The method of claim 2, wherein the computer-controlled manufacturing system comprises a two or more axis CNC milling system, the fixture is a soft jaw fixture, and the obtaining comprises:
determining a clamping location on the physical structure based on the three-dimensional model of the physical structure;
selecting a direction of clamping load at the clamping location; and
selecting a direction of machining force to be applied to the physical structure;
wherein the producing comprises producing the three-dimensional model of the fixture based on the clamping location, the direction of the clamping load, and the direction of the machining force.

7. The method of claim 1, wherein simulating the manufacturing process includes simulating effects of the one or more sensors on the manufacturing process in accordance with one or more predefined physical attributes of the one or more sensors and the placement of the one or more sensors, and the method comprises:
modifying the one or more locations of the one or more sensors based on the simulated data to improve (i) data quality for the one or more sensors at the one or more locations, and/or (ii) performance of the fixture, during actual manufacturing of the physical structure; and
providing the one or more locations of the one or more sensors for use during the manufacturing process for the physical structure performed by the computer-controlled manufacturing system using the fixture and the one or more sensors at the one or more locations.

8. The method of claim 7, wherein the one or more sensors comprise a load cell comprising a flexture, and modifying the three-dimensional model of the fixture comprises changing a shape of the fixture at a location of the flexture to cause the fixture to flex in a specific direction to improve data quality from the load cell.

9. The method of claim 7, wherein the one or more sensors comprise a temperature sensor, and modifying the three-dimensional model of the fixture comprises changing a shape of the fixture to account for thermal expansion of the fixture, or of the physical structure, to improve performance of the fixture during the manufacturing process for the physical structure.

10. The method of claim 7, wherein the one or more sensors comprise a vibration sensor, modifying the one or more locations comprises moving the vibration sensor to change a natural resonance of the physical structure in the fixture, and modifying the three-dimensional model of the fixture comprises changing a shape of the fixture to detune the fixture such that the natural resonance is counteracted by a manner in which the fixture holds the physical structure during the manufacturing process for the physical structure.

11. The method of claim 1, comprising:
capturing real-world data using the one or more sensors during the manufacturing process for the physical structure performed by the computer-controlled manufacturing system using the fixture and the one or more sensors at the one or more locations.

12. The method of claim 11, comprising:
recalibrating simulated manufacturing based on a comparison of the real-world data with the simulated data to produce a recalibrated manufacturing simulation process; and
modifying the three-dimensional model of the fixture or a different three-dimensional model of a different fixture and/or modifying a location of at least one sensor for the fixture or for the different fixture using the recalibrated manufacturing simulation process.

13. The method of claim 11, comprising:
comparing the real-world data with the simulated data to produce a representation of differences between the manufacturing process and simulated manufacturing; and
presenting on a display device the representation of the differences between the manufacturing process and the simulated manufacturing.

14. The method of claim 11, comprising:
adjusting the manufacturing process for the physical structure performed by the computer-controlled manufacturing system based on the real-world data.

15. The method of claim 1, wherein the computer-controlled manufacturing system comprises a two or more axis CNC milling system, the manufacturing process for the physical structure comprises milling of the physical structure out of a workpiece, and the fixture comprises holding tabs formed from the workpiece during the milling of the physical structure out of the workpiece.

16. A non-transitory computer-readable medium tangibly encoding a computer program operable to cause data processing apparatus to perform operations comprising:
obtaining a toolpath specification to be used in a manufacturing process for a physical structure in a computer-controlled manufacturing system using a fixture to hold the physical structure;
simulating the manufacturing process using the toolpath specification and a placement of one or more sensors at one or more locations on and/or in the fixture and/or on and/or in the physical structure, wherein the simulating produces simulated data for the one or more sensors at the one or more locations in accordance with the placement;
modifying a three-dimensional model of the fixture based on the simulated data to improve (i) data quality for the one or more sensors at the one or more locations, and/or (ii) performance of the fixture, during the manufacturing process; and
providing the three-dimensional model of the fixture for use during the manufacturing process performed by the computer-controlled manufacturing system using the fixture and the one or more sensors at the one or more locations.

17. The non-transitory computer-readable medium of claim 16, wherein simulating the manufacturing process includes simulating effects of the one or more sensors on the manufacturing process in accordance with one or more predefined physical attributes of the one or more sensors and the placement of the one or more sensors, and the operations comprises:
modifying the one or more locations of the one or more sensors based on the simulated data to improve (i) data quality for the one or more sensors at the one or more locations, and/or (ii) performance of the fixture, during actual manufacturing of the physical structure; and
providing the one or more locations of the one or more sensors for use during the manufacturing process for the physical structure performed by the computer-controlled manufacturing system using the fixture and the one or more sensors at the one or more locations.

18. A system comprising:
a computer-controlled manufacturing system;
a data processing apparatus including at least one hardware processor; and
a non-transitory computer-readable medium encoding instructions configured to cause the data processing apparatus to
obtain a toolpath specification to be used in a manufacturing process for a physical structure in the computer-controlled manufacturing system using a fixture to hold the physical structure,
simulate the manufacturing process using the toolpath specification and a placement of one or more sensors at one or more locations on and/or in the fixture and/or on and/or in the physical structure, wherein simulation of the manufacturing process produces simulated data for the one or more sensors at the one or more locations in accordance with the placement,
modify a three-dimensional model of the fixture based on the simulated data to improve (i) data quality for the one or more sensors at the one or more locations, and/or (ii) performance of the fixture, during the manufacturing process, and
provide the three-dimensional model of the fixture for use during the manufacturing process performed by the computer-controlled manufacturing system using the fixture and the one or more sensors at the one or more locations.

19. The system of claim 18, wherein simulation of the manufacturing process includes simulation of effects of the one or more sensors on the manufacturing process in accordance with one or more predefined physical attributes of the one or more sensors and the placement of the one or more sensors, and the instructions are configured to cause the data processing apparatus to
modify the one or more locations of the one or more sensors based on the simulated data to improve (i) data quality for the one or more sensors at the one or more locations, and/or (ii) performance of the fixture, during actual manufacturing of the physical structure and
provide the one or more locations of the one or more sensors for use during the manufacturing process for the physical structure performed by the computer-controlled manufacturing system using the fixture and the one or more sensors at the one or more locations.

20. The system of claim 19, wherein the computer-controlled manufacturing system comprises a two or more axis CNC milling system.
